(19) United States
(12) Patent Application Publication
(10) Pub. No.: US 2024/0140421 A1
(43) Pub. Date: May 2, 2024

(54) VEHICLE DECELERATION SUPPORT DEVICE

(71) Applicant: TOYOTA JIDOSHA KABUSHIKI KAISHA, Toyota-shi (JP)

(72) Inventors: Koki SUWABE, Toyota-shi (JP); Yuki TEZUKA, Toyota-shi (JP)

(73) Assignee: TOYOTA JIDOSHA KABUSHIKI KAISHA, Toyota-shi (JP)

(21) Appl. No.: 18/447,430

(22) Filed: Aug. 10, 2023

(30) Foreign Application Priority Data
Oct. 31, 2022 (JP) 2022-174774

(51) Int. Cl. B60W 30/14; B60W 10/18; B60W 10/20; B60W 30/165; B60W 40/105; B60W 50/14

(52) U.S. Cl. CPC B60W 30/146; B60W 10/18; B60W 10/20; B60W 30/165; B60W 40/105; B60W 50/14; B60W 2520/125; B60W 2554/80

(57) ABSTRACT

A deceleration support device is applied to a vehicle provided with a steering assist device that requests a driver to perform hands-on when a vehicle speed or a lateral acceleration of the vehicle exceeds a corresponding control reference value in a situation where a steering mode is a hands-off mode, and includes a control unit that calculates a target deceleration based on a traveling situation of the vehicle when the vehicle needs to be decelerated, and decelerates the vehicle based on the target deceleration. The control unit calculates the target deceleration so that neither the vehicle speed nor the lateral acceleration of the vehicle exceeds the corresponding control reference value when the vehicle needs to be decelerated in a situation where the steering mode is the hands-off mode.

### CROSS-REFERENCE TO RELATED APPLICATION

This application claims priority to Japanese Patent Application No. 2022-174774 filed on Oct. 31, 2022, incorporated herein by reference in its entirety.

### BACKGROUND

### 1. Technical Field

The present disclosure relates to a deceleration support device for a vehicle such as an automobile.

### 2. Description of Related Art

As one of deceleration support devices for a vehicle such as an automobile, there is known a deceleration support device that automatically decelerates the vehicle to reduce the vehicle speed so that the vehicle travels safely without straying from a lane in a case where it is determined that the vehicle speed is excessively high when the vehicle travels along the lane.

For example, paragraphs [0187] and [0220] of Japanese Unexamined Patent Application Publication No. 08-202990 (JP 08-202990 A) describe a deceleration support device that performs vehicle speed control so that a vehicle speed reduces when it is determined that a current vehicle speed is excessively higher compared to a vehicle speed for a vehicle to safely travel along a curve, in a situation in which a curve of a road exists in front of the vehicle.

### SUMMARY

As one of driving support devices for a vehicle such as an automobile, there is known a lane keeping control device that causes the vehicle to travel along a lane by automatically steering a steering wheel without requiring a steering operation by a driver. In the lane keeping control device, automatic steering is performed when a steering mode is a hands-off mode, and when it is determined that a vehicle speed and magnitude of a lateral acceleration of the vehicle exceed a preset reference value, a request for hands-on is notified to the driver. Further, when it is determined that the driver has grasped the steering wheel, the steering mode is switched to a hands-on mode.

When the steering mode is the hands-off mode, the coping ability of the driver with respect to the driving operation is lower than when the steering mode is the hands-on mode. Therefore, when the steering mode is the hands-off mode, it is conceivable to set the preset reference value to a smaller value than when the steering mode is the hands-on mode.

However, when the reference value is set to a small value, it is easily determined that the vehicle speed and the magnitude of the lateral acceleration of the vehicle has exceeded the reference value. Therefore, since the request for hands-on is easily notified to the driver, it is more likely that the driver finds the request for hands-on annoying.

The present disclosure provides an improved deceleration support device so that the driver does not find the request for hands-on annoying even when the vehicle is decelerated by automatic braking in a situation in which the steering mode is the hands-off mode.

According to the present disclosure, a vehicle deceleration support device (100) is provided that is applied to a vehicle (102) provided with a steering assist device (EPS-ECU 40, EPS device 42) configured to perform automatic steering by an automatic steering device (46) (S80) when a steering mode is a hands-off mode (S20), and request a driver to perform hands-on when one of a vehicle speed (V) and a lateral acceleration (Gy) of the vehicle exceeds a corresponding control reference value (Vm, Gym) in a situation in which the steering mode is the hands-off mode (S50), and that includes an automatic braking device (braking ECU 30, braking device 32) that performs automatic braking, a traveling situation detection device (object information acquisition device 16 and navigation device 80) that detects a traveling situation of the vehicle, and a control unit (driving support ECU 10) configured to, when determination is made that the traveling situation of the vehicle is a traveling situation in which the vehicle needs to be decelerated (S200, S230), calculate a target deceleration (Gbvt2, Gbgt2) based on the traveling situation of the vehicle (S210, S240), and decelerate the vehicle by the automatic braking such that a deceleration (Gb) of the vehicle becomes the target deceleration.

The control unit (driving support ECU 10) is configured to calculate the target deceleration such that neither the vehicle speed nor the lateral acceleration of the vehicle exceeds the corresponding control reference value when the vehicle is decelerated by the automatic braking in the situation in which the steering mode is the hands-off mode (S120 to S190).

According to the above-described deceleration support device, in a situation in which the steering mode is the hands-off mode, when the vehicle is decelerated by the automatic braking, the target deceleration is calculated such that neither the vehicle speed nor the lateral acceleration of the vehicle exceeds the corresponding control reference value. Therefore, since neither the vehicle speed nor the lateral acceleration of the vehicle exceeds the corresponding control reference value, the driver will not be requested to perform hands-on caused by the vehicle speed and/or the lateral acceleration of the vehicle exceeding the corresponding control reference value. Therefore, it is possible to suppress the driver from feeling annoyed by the request for hands-on.

In one aspect of the present disclosure, the control unit (driving support ECU 10) may be configured to calculate the target deceleration (Gbvt1, Gbgt1) as a target deceleration for making both the vehicle speed and the lateral acceleration of the vehicle equal to or less than a corresponding first reference value when determination is made that one of the vehicle speed (V) and the lateral acceleration (Gy) of the vehicle is greater than the corresponding first reference value (V1, Gy1) (S130, S160) in a case in which the steering mode is the hands-off mode (S120) (S130 to S190), and the first reference value (V1, Gy1) may be set to a value smaller than the control reference value (Vm, Gym).

In another aspect of the present disclosure, the control unit (driving support ECU 10) may be configured to calculate the target deceleration (Gbvt2, Gbgt2) as a target deceleration for making both the vehicle speed and the lateral acceleration of the vehicle equal to or less than a corresponding second reference value when determination is made that one of the vehicle speed (V) and the lateral acceleration (Gy) of the vehicle is greater than the corresponding second reference value (V2, Gy2) (S200, S230) in a case in which the steering mode is a hands-on mode (S120), and the second reference value (V2, Gy2) may be set to a value greater than the first reference value (V1, Gy1). Furthermore, in another aspect of the present disclosure, the control unit (driving support ECU 10) may calculate a target deceleration (Gbvt1) based on a first vehicle speed for making the vehicle speed equal to or less than the corresponding first reference value (S140) when determination is made that the vehicle speed (V) is greater than the corresponding first reference value (V1) (S130) in the situation in which the steering mode is the hands-off mode (S120), calculate a target deceleration (Gbgt1) based on a first lateral acceleration for making the lateral acceleration of the vehicle equal to or less than the corresponding first reference value when determination is made that the lateral acceleration (Gy) of the vehicle is greater than the corresponding first reference value (Gy1) (S160) in the situation in which the steering mode is the hands-off mode (S120), and set a higher value of the target deceleration based on the first vehicle speed and the target deceleration based on the first lateral acceleration as the target deceleration (Gbt) when the steering mode is the hands-off mode (S190).

Furthermore, in another aspect of the present disclosure, the vehicle may be a vehicle in which follow-up vehicle-to-vehicle distance control is performed.

In the above description, in order to help understanding of the present disclosure, the names and/or the reference signs used in the embodiment are added in parentheses to the configurations of the disclosure corresponding to the embodiment to be described later. However, each component of the present disclosure is not limited to the component of the embodiment corresponding to the name and/or the reference sign attached in parentheses. Other objects, other features and accompanying advantages of the present disclosure will be readily understood from the description of embodiments of the present disclosure described with reference to the following drawings.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram illustrating a deceleration support device according to an embodiment;

FIG. 2 is a flowchart illustrating a steering mode control routine according to the embodiment;

FIG. 3 is a flowchart illustrating a deceleration support control routine according to the embodiment;

FIG. 4A is a diagram showing a state in which the vehicle travels straight in the steering mode in the hands-off mode;

FIG. 4B is a diagram illustrating a condition in which a vehicle travels straight ahead in the steering mode in the hands-off mode for the embodiment;

FIG. 5A is a diagrammatic representation of the prior art situation in which the vehicle travels curved in the steering mode of the hands-off mode;

FIG. 5B is a diagram illustrating a condition in which a vehicle travels on a curve in a steering mode in a hands-off mode for an embodiment; and

FIG. 6 is a flowchart illustrating a main part of a deceleration support control routine according to a modification.

### DETAILED DESCRIPTION OF EMBODIMENTS

Hereinafter, a deceleration support device according to an embodiment of the present disclosure will be described in detail with reference to the accompanying drawings.

### Configuration

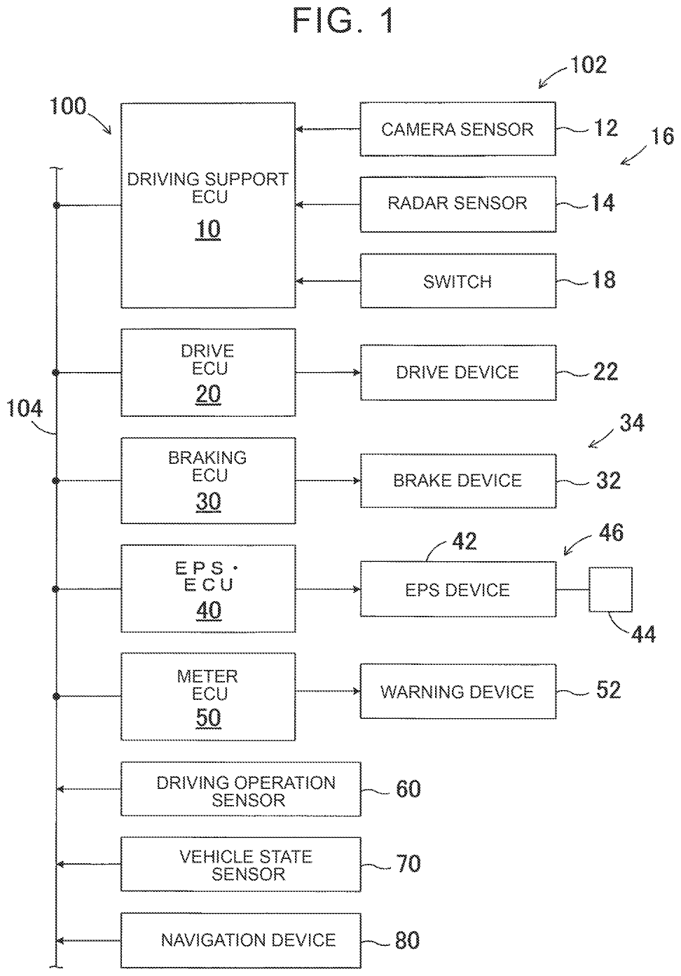

As shown in FIG. 1, a deceleration support device 100 according to an embodiment of the present disclosure is applied to a vehicle 102 and includes a driving support ECU 10. The vehicle 102 may be a vehicle capable of automated driving, and includes a drive ECU 20, a braking ECU 30, an electric power steering ECU 40, and a meter ECU 50. ECU means an Electronic Control Unit including a microcomputer as a main part. In the following explanation, the electric power steering is referred to as an EPS.

A microcomputer of each ECU includes a central processing unit (CPU), a read-only memory (ROM), a random access memory (RAM), a readable and writable non-volatile memory (N/M), an interface (I/F), and the like. The CPU realizes various functions by executing instructions (programs, routines) stored in the ROM. Furthermore, these ECU are connected to each other in a data-exchangeable manner via a Controller Area Network (CAN) 104. Therefore, detected values of sensors (including switches) connected to a specific ECU are transmitted to other ECUs as well.

The driving support ECU 10 is a central control device that performs driving support control such as deceleration assistance control, tracking inter-vehicle distance control, and lane keeping control. In the embodiment, the driving support ECU 10 performs the deceleration assistance control, the following inter-vehicle distance control, and the lane keeping control in cooperation with other ECU, as will be described later. In the present application, the following inter-vehicle distance control and the lane keeping control are abbreviated as Adaptive Cruise Control (ACC) and Lane Tracing Assist (LTA), respectively, as needed.

A camera sensor 12, a radar sensor 14, and a switch 18 are connected to the driving support ECU 10. The camera sensor 12 and radar sensor 14 each include a plurality of camera devices and a plurality of radar devices. The camera sensor 12 and the radar sensor 14 function as an object information acquisition device 16 that acquires information on targets around the vehicle 102.

Each camera device of the camera sensor 12 includes a camera unit that captures an image of the surroundings of the vehicle 102, and a recognition unit that analyzes image data obtained by capturing an image by the camera unit and recognizes a target such as a white line of a road or another vehicle, although not shown in the drawing. The recognition unit supplies information about the recognized target to the driving support ECU 10 at predetermined intervals.

Each radar device of the radar sensor 14 includes a radar transceiver and a signal processor (not shown). The radar transceiver emits a millimeter-wave band radio wave (hereinafter, referred to as “millimeter wave”), and receives a millimeter wave (that is, a reflected wave) reflected by a three-dimensional object (for example, another vehicle, a guardrail, or the like) existing in a radiation range. The signal processor supplies information indicating a distance between the host vehicle and the three-dimensional object, a relative speed between the host vehicle and the three-dimensional object, a relative position (direction) of the three-dimensional object with respect to the host vehicle, and the like to the driving support ECU 10 at predetermined time intervals on the basis of a phase difference between the transmitted millimeter wave and the received reflected wave, an attenuation level of the reflected wave, a time period from the transmission of the millimeter wave to the reception of the reflected wave, and the like. Note that a Light Detection And Ranging (LiDAR) may be used instead of the radar sensor 14 or in addition to the radar sensor 14.

The switch 18 is provided at a position operable by a driver, and is switched on and off by the driver. Although not shown in FIG. 1, the switch 18 includes a deceleration assist switch, an ACC switch, and a LTA switch, and deceleration assist control, ACC, and LTA are executed when these switches are on, respectively.

ACC includes two types of control: constant speed travel control and preceding vehicle follow-up control. The constant speed travel control is a control for adjusting the braking and driving force of the vehicle so that the vehicle speed V of the vehicle 102 coincides with the target vehicle speed (set speed) Vt without requiring a braking and driving operation by the driver. The preceding vehicle following control is a control for causing the preceding vehicle to follow the preceding vehicle while maintaining the inter-vehicle distance D between the preceding vehicle (the following target vehicle) and the host vehicle 102 in the target inter-vehicle distance Dt without requiring a braking and driving operation by the driver. The preceding vehicle is a vehicle that is in the front region of the host vehicle 102 and travels immediately before the host vehicle, and is determined based on the information of the target acquired by the object information acquisition device 16. It should be noted that the target vehicle speed Vt and the target inter-vehicle distance Dt can be variably set by operating a setting operation device not shown in FIG. 1.

LTA is a control that sets a target trajectory of the vehicle when the steering mode is the hands-off mode, and automatically steers the steered wheels by the automatic steering device so that the vehicle travels along the target trajectory. The target trajectory is set to the center line of the lane, for example, based on the white line of the lane in front of the vehicle 102, or is set to the trajectory of the preceding vehicle. The white line of the lane is specified based on the information in front of the vehicle 102 acquired by the object information acquisition device 16. Note that, as will be described later, even if LTA switch is on, when a predetermined condition is satisfied, the driver is requested to perform hands-on, and when the driver grasps the steering wheel, the steering mode is switched to the hands-on mode.

The drive ECU 20 is connected with a drive device 22 that accelerates the vehicle 102 by applying a driving force to driving wheels not shown in FIG. 1. In a normal state, the drive ECU 20 controls the drive device 22 so that the driving force generated by the drive device 22 changes in response to a driving operation by the driver, and when a command signal is received from the driving support ECU 10, controls the drive device 22 based on the command signal. The drive device 22 may be any drive device known in the art.

A braking device 32 is connected to the braking ECU 30 to decelerate the vehicle 102 by braking by applying braking force to wheels not shown in FIG. 1. In a normal state, the braking ECU 30 controls the braking device 32 so that the braking force generated by the braking device 32 changes in accordance with the braking operation by the driver, and when a command signal is received from the driving support ECU 10, automatically braking is performed by controlling the braking device 32 based on the command signal. Thus, the braking ECU 30 and the braking device 32 function as the automatic braking device 34.

A EPS device 42 is connected to EPS-ECU 40. EPS-ECU 40 controls the steering assist torque by controlling EPS device 42 in a manner known in the art on the basis of the steering torque Ts and the vehicle speed V detected by the driving operation sensor 60 and the vehicle state sensor 70, which will be described later, to reduce the steering burden on the driver. Further, EPS-ECU 40 can steer the steered wheels as needed by controlling EPS device 42. Thus, EPS-ECU 40 and EPS device 42 functions as an automatic steering device 46 that automatically steers the steered wheels 44 as needed.

A notification device 52 is connected to the meter ECU 50. When it is determined that the need for hands-on has occurred in a situation where the steering mode of LTA is the hands-off mode, the notification device 52 notifies the driver that the hands-on is requested. Hold the steering wheel on the display, for example, for this notification. In addition to this indication, a visual alarm such as an alarm lamp and an audible alarm such as a buzzer may be issued.

The driving operation sensor 60 and the vehicle state sensor 70 are connected to CAN 104. Information (referred to as sensor information) detected by the driving operation sensor 60 and the vehicle state sensor 70 is transmitted to CAN 104. The sensor data transmitted to CAN 104 can be appropriately used in the respective ECU. Note that the sensor information is information of a sensor connected to a specific ECU, and may be transmitted from the specific ECU to CAN 104.

In addition, a navigation device 80 is also connected to CAN 104. The navigation device 80 includes a global positioning system (GPS) receiver that detects the position of the vehicle 102, a storage device that stores map information and road information, and a communication device that acquires the latest information of the map information and the road information from the outside. The navigation device 80 functions as a device for acquiring information on the current location of the vehicle 102, and outputs, to the driving support ECU 10, a signal indicating the current location of the vehicle on the map and information on its surroundings.

As can be seen from the above description, in the embodiment, the object information acquisition device 16 and the navigation device 80 function as a traveling situation detection device when information such as a road around the vehicle 102 is acquired.

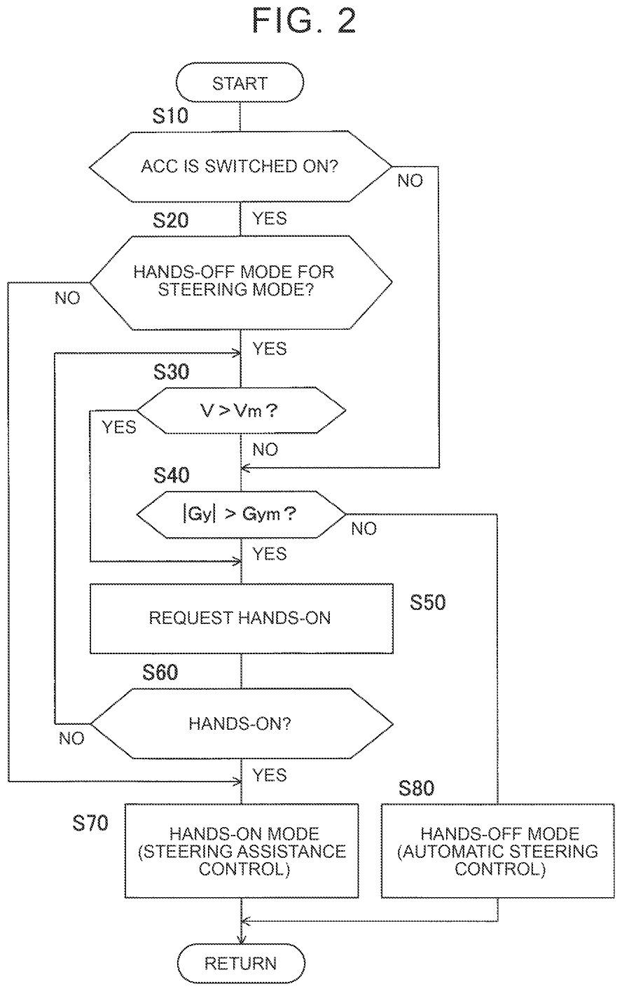

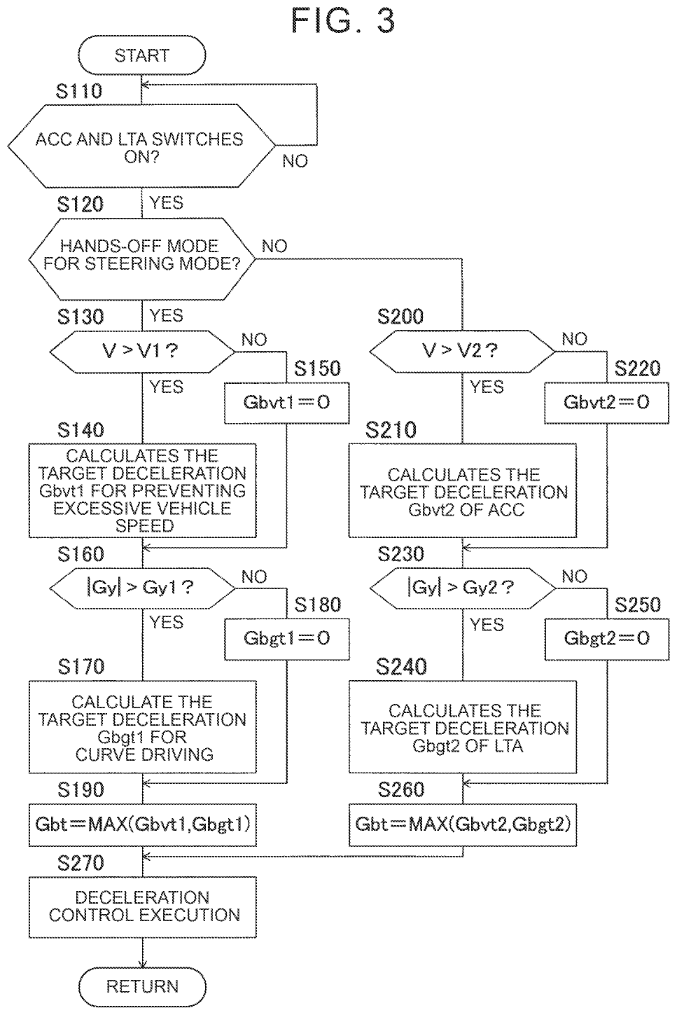

In an embodiment, ROM of EPS-ECU 40 stores a steering-mode control program, which corresponds to the flow chart shown in FIG. 2. ROM of the driving support ECU 10 stores a deceleration assistance control program, which corresponds to the flow chart shown in FIG. 3.

### Steering Mode Control Program (FIG. 2)

Next, the steering mode control according to the embodiment will be described with reference to the flowchart shown in FIG. 2. The steering-mode control according to the flow chart shown in FIG. 2 ends when LTA switch is on, EPS-ECU 40 is repeatedly executed at predetermined intervals by CPU, and LTA switch is turned off.

First, in S10, CPU determines whether ACC is switched on, that is, whether ACC is being executed. When a negative determination is made, CPU advances the steering-mode control to S40. When an affirmative determination is made, CPU advances the steering-mode control to S20.

In S20, CPU determines whether the steering mode is a hands-off mode. When a negative determination is made, CPU advances the steering-mode control to S70. When an affirmative determination is made, CPU advances the steering-mode control to S30.

In S30, CPU determines whether or not the vehicle speed V of the vehicle 102 exceeds the control reference value Vm (positive value) related to the vehicle speed. When an affirmative determination is made, CPU advances the steering-mode control to S50. When a negative determination is made, CPU advances the steering-mode control to S40. Note that the control reference value Vm may be the largest value of the vehicle speed that is allowed when the vehicle 102 is caused to travel along the lane by the autopilot.

In S40, CPU determines whether the absolute value of the lateral acceleration Gy of the vehicle 102 exceeds a control reference value Gym (positive constant) related to the lateral acceleration. When a negative determination is made, CPU advances the steering-mode control to S80. When an affirmative determination is made, CPU advances the steering-mode control to S50. Note that the control reference value Gym may be the largest value of the absolute value of the lateral acceleration Gy that is allowed when the vehicle 102 is caused to travel along the lane of the curve by the autopilot.

In S50, CPU determines that hands-on is required when the steering mode is the hands-off mode, and outputs a command to the meter ECU 50. In this way, the notification device 52 is used to notify the driver of a request for hands-on.

In S60, CPU determines whether the driver's steering is hands-on. When a negative determination is made, CPU maintains the steering mode in the hands-off mode and returns the steering mode control to S30. When an affirmative determination is made, CPU advances the steering-mode control to S70. In this case, for example, when it is detected by the touch sensor of the driving operation sensor 60 that the driver is gripping the steering wheel, it may be determined that the steering of the driver is hands-on. Note that, although not shown in FIG. 2, when a negative determination is made when ACC is switched off, the steering-mode control may be returned to S40 instead of S30.

In S70, CPU sets the steering mode to the hands-on mode, and notifies the driver of this by the notification device 52. Therefore, LTA is not executed, and the steering assist control for assisting the steering of the steered wheels 44 by the manual steering of the driver is performed as in the lane keeping control.

In S80, CPU sets the steering mode to the hands-off mode, and notifies the driver of this by the notification device 52. Therefore, LTA is executed, and the steering of the steered wheels 44 is automatically performed by the automatic steering device 46.

As can be seen from the above explanation, when both the vehicle speed V and the lateral acceleration Gy of the vehicle are equal to or less than the corresponding control reference value Vm and Gym (S30, S40), the automatic steering device 46 automatically steers the steered wheels so that the vehicle 102 travels along the lane. Therefore, the automatic steering device 46 functions as a steering assist device that executes LTA.

Further, when EPS-ECU 40 determines that one of the vehicle speed V and the absolute value of the lateral acceleration Gy of the vehicle 102 exceeds the corresponding control reference value in a state where the steering mode is the hands-off mode (S20), it notifies the driver of the request for the hands-on (S50 from S30).

### Deceleration Support Control Program (FIG. 3)

Next, the deceleration support control according to the embodiment will be described with reference to the flowchart shown in FIG. 3. The deceleration assistance control according to the flow chart shown in FIG. 3 is repeatedly executed at predetermined intervals by CPU of the driving support ECU 10 when the deceleration assistance switch is on, and is ended when the deceleration assistance switch is off. In the following description, the deceleration support control is referred to as “main control”.

First, in S110, CPU determines whether or not ACC switch and LTA switch are on. When a negative determination is made, CPU ends this control once. When an affirmative determination is made, CPU advances the control to S120.

In S120, CPU determines whether the steering mode is a hands-off mode. When a negative determination is made, CPU advances the present control to S200. When an affirmative determination is made, CPU advances the control to S130.

In S130, CPU determines whether or not the vehicle speed V of the vehicle 102 is greater than a first reference value V1 (positive value) related to the vehicle speed. When a negative determination is made, the present control proceeds to S150. When an affirmative determination is made, CPU advances the control to S140. The first reference value V1 is a value smaller than a control reference value Vm (S30) related to the vehicle speed of the steering-mode control.

In S140, CPU calculates a first target deceleration Gbvt1 for making the vehicle speed V equal to or lower than the first reference value V1 so that the target deceleration for suppressing the vehicle speed from becoming excessive, that is, the vehicle speed V does not exceed the control reference value Vm. On the other hand, in S150, CPU sets the first target deceleration Gbvt1 to 0.

In S160, CPU determines whether the absolute value of the lateral acceleration Gy of the vehicle 102 is greater than a first reference value Gy1 (positive constant) related to the lateral acceleration. When a negative determination is made, CPU advances the present control to S180. When an affirmative determination is made, CPU advances the control to S170. The first reference value Gy1 is a value smaller than the control reference value Gym (S40) related to the lateral acceleration of the steering-mode control.

In S170, CPU calculates a first target deceleration Gbgt1 for causing the vehicle to travel in a curve so that the lateral acceleration does not become excessive, that is, the absolute value of the lateral acceleration Gy does not exceed the control reference value Gym, so that the absolute value of the lateral acceleration Gy is equal to or less than the first reference value Gy1. On the other hand, in S180, CPU sets the first target deceleration Gbgt1 to 0.

In S190, CPU sets the larger of the first target deceleration Gbvt1 and the first target deceleration Gbgt1 to the target deceleration Gbt of the vehicle 102. Note that MAX in S190 of FIGS. 3 and S260 to be described later means that the larger one of the two values in parentheses is selected.

In S200, CPU determines whether or not the vehicle speed V of the vehicle 102 is greater than a second reference value V2 (positive value) related to the vehicle speed of ACC. When a negative determination is made, CPU advances the present control to S220. When an affirmative determination is made, CPU advances the control to S210. The second reference value V2 is a value larger than the first reference value V1 (S130) related to the vehicle speed, and is a target vehicle speed (set speed) Vt of the constant speed travel control of ACC. Further, the second reference value V2 may be a value greater than the control reference value Vm (S30) relating to the vehicle speed of the steering-mode control.

Note that, as described above, since the target vehicle speed Vt can be variably set, when the target vehicle speed Vt is changed, the second reference value V2 may be changed correspondingly while maintaining the above-described magnitude relation, and the first reference value V1 and the control reference value Vm may be changed.

In S210, CPU calculates a second target deceleration Gbvt2 for making the vehicle speed V equal to or lower than the second reference value V2 as a target deceleration for suppressing the vehicle speed from becoming excessive. On the other hand, in S220, CPU sets the second target deceleration Gbvt2 to 0.

Note that since the second reference value V2 is the target vehicle speed Vt of the constant speed travel control of ACC, S200 to S220 are executed as part of ACC.

In S230, CPU determines whether the absolute value of the lateral acceleration Gy of the vehicle 102 is greater than a second reference value Gy2 (positive constant) for the lateral acceleration. When a negative determination is made, CPU advances the present control to S250. When an affirmative determination is made, CPU advances the control to S240. The second reference value Gy2 is a value larger than the first reference value Gy1 (S160) related to the lateral acceleration. Further, the second reference value Gy2 may be a value that is greater than the control reference value Gym (S40) relating to the lateral acceleration of the steering-mode control.

In S240, CPU calculates a second target deceleration Gbgt2 for making the absolute value of the lateral acceleration Gy equal to or less than the second reference value Gy2 as a target deceleration for causing the vehicle to travel in a curve so that the lateral acceleration does not become excessive. On the other hand, in S250, CPU sets the second target deceleration Gbgt2 to 0.

In S260, CPU sets the larger of the second target deceleration Gbvt2 and the second target deceleration Gbgt2 to the target deceleration Gbt of the vehicle 102.

In S270, CPU executes deceleration control for controlling the automatic braking device 34 so that the deceleration Gb of the vehicle 102 becomes the target deceleration Gbt by outputting a command signal to the braking ECU 30.

As can be seen from the above explanation, according to the deceleration support control of the embodiment, when the steering mode is the hands-off mode (S120), the vehicle speed V of the vehicle 102 is controlled to be substantially equal to or lower than the first reference value V1 (from S130 to S150). Since the first reference value V1 is smaller than the control reference value Vm (S30), the vehicle speed V of the vehicle 102 is prevented from exceeding the control reference value Vm. Therefore, it is possible to prevent the driver from being notified of the request for hands-on in S50 by making an affirmative determination in S30, and thus it is possible to suppress the driver from remembering the troublesomeness of the driver being notified of the request for hands-on.

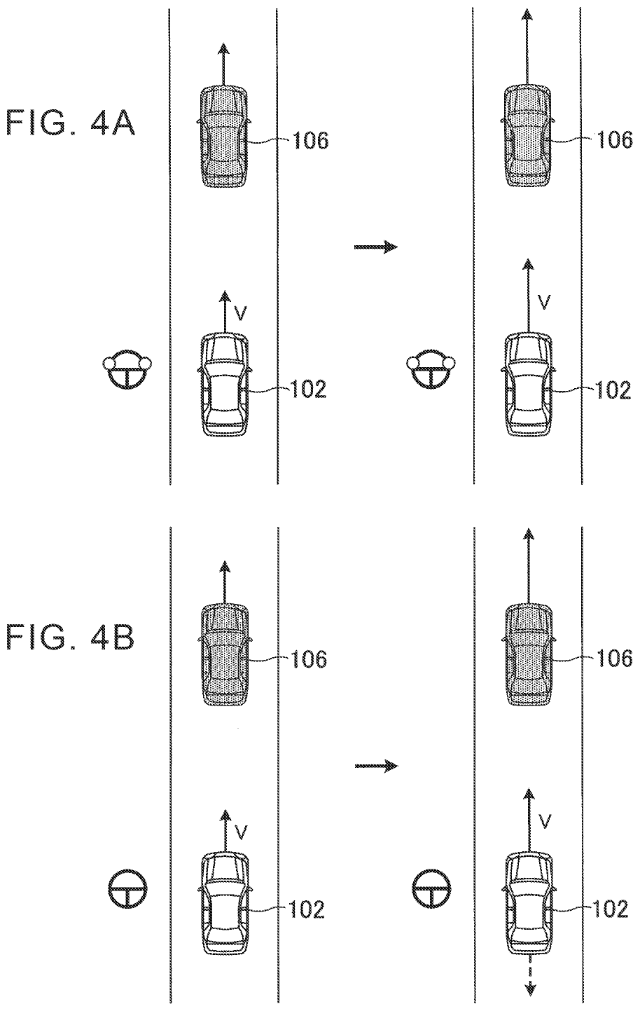

For example, FIG. 4A and FIG. 4B show a situation in which the vehicle travels straight in the steering mode in the hands-off mode. In FIG. 4A of the prior art, for example, when the preceding vehicle 106 accelerates suddenly, the vehicle 102 also accelerates suddenly and the vehicle speed V increases so that the inter-vehicle distance is maintained at the set value. Therefore, the hands-on request is notified every time the vehicle speed V exceeds the control reference value Vm.

On the other hand, in FIG. 4B of the embodiment, even if the preceding vehicle 106 accelerates rapidly and the vehicle 102 also attempts to accelerate rapidly, the vehicle speed V is decelerated to be substantially equal to or less than the first reference value V1. Therefore, since the vehicle speed V does not exceed the control reference value Vm, the request for hands-on is not notified.

When the steering mode is the hands-off mode (S120), the absolute value of the lateral acceleration Gy of the vehicle 102 is controlled to be substantially equal to or less than the first reference value Gy1 (from S160 to S180). Since the first reference value Gy1 is smaller than the control reference value Gym (S40), the absolute value of the lateral acceleration Gy of the vehicle 102 is prevented from exceeding the control reference value Gym. Therefore, it is possible to suppress the driver from being notified of the request for hands-on in S50 by making an affirmative determination in S40, and thus it is possible to suppress the driver from remembering the troublesomeness of the driver being notified of the request for hands-on.

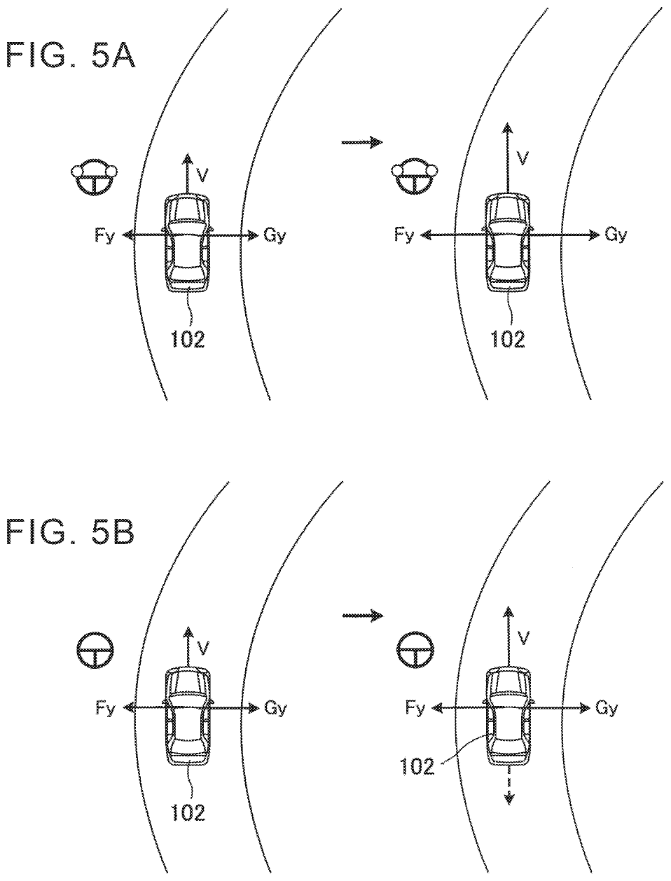

For example, FIG. 5A and FIG. 5B show a situation in which the vehicle travels in a curve in the steering mode in the hands-off mode. In FIG. 5A of the prior art, for example, when the vehicle 102 accelerates, the absolute values of the lateral acceleration Gy and the centrifugal force Fy of the vehicle increase. Therefore, the hands-on request is notified every time the absolute value of the lateral acceleration Gy exceeds the control reference value Gym.

On the other hand, in the FIG. 5B of the embodiment, the vehicle 102 is accelerated, and the absolute value of the lateral acceleration Gy is decelerated to be substantially equal to or less than the first reference value Gy1 even when the absolute value of the lateral acceleration Gy and the absolute value of the centrifugal force Fy of the vehicle are increased. Therefore, since the absolute value of the lateral acceleration Gy does not exceed the control reference value Vm, the request for hands-on is not notified.

When the steering mode is the hands-on mode, the vehicle speed V of the vehicle 102 may exceed the control reference value Vm (S30) or the absolute value of the lateral acceleration Gy of the vehicle 102 may exceed the control reference value Gym (S40). However, when the steering mode is the hands-on mode, since a negative determination is made in S20 of the steering mode control, S50 is not executed. Therefore, since the driver is not notified of the request for hands-on, the driver does not feel troublesome about the driver being notified of the request for hands-on.

Further, according to the embodiment, the first target deceleration Gbgt1 for setting the absolute value of the first target deceleration Gbvt1 and the lateral acceleration Gy for setting the vehicle speed V to be equal to or lower than the first reference value V1 to be equal to or lower than the first reference value Gy1 is calculated. Further, the higher one of the first target deceleration Gbvt1 and the first target deceleration Gbgt1 is the target deceleration Gbt when the steering mode is the hands-off mode.

Therefore, both of the vehicle speed V and the absolute value of the lateral acceleration Gy can be reliably set to the first reference value V1 and Gy1 or less corresponding to each other. Therefore, since both of the vehicle speed V and the absolute value of the lateral acceleration Gy can be reliably set to the corresponding control reference value Vm and Gym or less, it is possible to effectively suppress the driver from being notified of the hands-on request even when the vehicle 102 accelerates while traveling in the curve.

The present disclosure has been described in detail above with respect to specific embodiments. However, it is obvious to those skilled in the art that the present disclosure is not limited to the above-described embodiments, and various other embodiments are possible within the scope of the present disclosure.

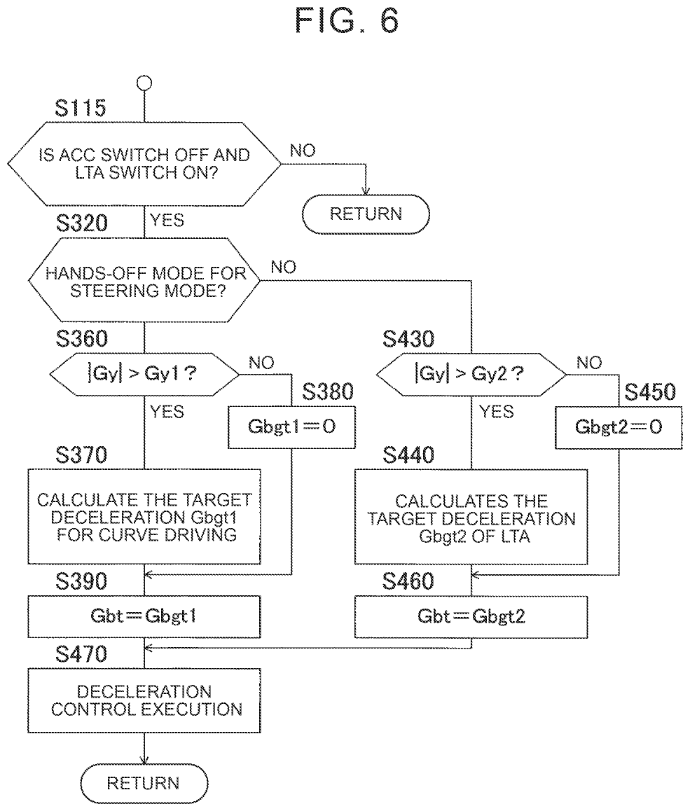

For example, in the above-described embodiment, when a negative determination is made in S110, the present control is temporarily ended. However, as illustrated as a modification in FIG. 6, in S110, when a negative determination is made, it is determined in S115 whether ACC switch is off and LTA switch is on, and when a negative determination is made, the present control is terminated once, but when an affirmative determination is made, S320 and subsequent steps may be executed.

Note that S320 corresponds to S120, S360 to S380 corresponds to S160 to S180, and S430 to S450 corresponds to S230 to S250, and in S390, the target deceleration Gbt of the vehicle 102 is set to the first target deceleration Gbgt1, and in S460, the target deceleration Gbt of the vehicle 102 is set to the second target deceleration Gbgt2.

According to this modification, it is possible to suppress the driver from being notified of the hands-on request when ACC switch is turned off and the vehicle 102 accelerates in a curve running condition.

Further, in the above-described embodiment, both ACC and LTA are performed, but the deceleration support device of the present disclosure may be applied to vehicles in which LTA is performed but ACC is not performed.

What is claimed is:

1. A vehicle deceleration support device that is applied to a vehicle provided with a steering assist device configured to perform automatic steering by an automatic steering device when a steering mode is a hands-off mode, and request a driver to perform hands-on when one of a vehicle speed and a lateral acceleration of the vehicle exceeds a corresponding control reference value in a situation in which the steering mode is the hands-off mode, the vehicle deceleration support device comprising:
an automatic braking device that performs automatic braking;
a traveling situation detection device that detects a traveling situation of the vehicle; and
a control unit configured to, when determination is made that the traveling situation of the vehicle is a traveling situation in which the vehicle needs to be decelerated, calculate a target deceleration based on the traveling situation of the vehicle, and decelerate the vehicle by the automatic braking such that a deceleration of the vehicle becomes the target deceleration, wherein the control unit is configured to calculate the target deceleration such that neither the vehicle speed nor the lateral acceleration of the vehicle exceeds the corresponding control reference value when the vehicle is decelerated by the automatic braking in the situation in which the steering mode is the hands-off mode.

2. The vehicle deceleration support device according to claim 1, wherein the control unit is configured to calculate the target deceleration as a target deceleration for making both the vehicle speed and the lateral acceleration of the vehicle equal to or less than a corresponding first reference value when determination is made that one of the vehicle speed and the lateral acceleration of the vehicle is greater than the corresponding first reference value in a case in which the steering mode is the hands-off mode, and the first reference value is set to a value smaller than the control reference value.

3. The vehicle deceleration support device according to claim 2, wherein the control unit is configured to calculate the target deceleration as a target deceleration for making both the vehicle speed and the lateral acceleration of the vehicle equal to or less than a corresponding second reference value when determination is made that one of the vehicle speed and the lateral acceleration of the vehicle is greater than the corresponding second reference value in a case in which the steering mode is a hands-on mode, and the second reference value is set to a value greater than the first reference value.

4. The vehicle deceleration support device according to claim 2, wherein the control unit calculates a target deceleration based on a first vehicle speed for making the vehicle speed equal to or less than the corresponding first reference value when determination is made that the vehicle speed is greater than the corresponding first reference value in the situation in which the steering mode is the hands-off mode, calculates a target deceleration based on a first lateral acceleration for making the lateral acceleration of the vehicle equal to or less than the corresponding first reference value when determination is made that the lateral acceleration of the vehicle is greater than the corresponding first reference value in the situation in which the steering mode is the hands-off mode, and sets a higher value of the target deceleration based on the first vehicle speed and the target deceleration based on the first lateral acceleration as the target deceleration when the steering mode is the hands-off mode.

5. The vehicle deceleration support device according to claim 1, wherein the vehicle is a vehicle in which follow-up vehicle-to-vehicle distance control is performed.
